(19) United States
(12) Patent Application Publication
(10) Pub. No.: US 2007/0021255 A1
(43) Pub. Date: Jan. 25, 2007

(54) Vehicle-use generator

(75) Inventor: Yuji Ito, Hekinan-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/487,569

(22) Filed: Jul. 17, 2006

(30) Foreign Application Priority Data
Jul. 20, 2005 (JP) 2005-209344

(51) Int. Cl. F16H 55/06

(52) U.S. Cl. 474/161; 310/75 D; 310/68 D

(57) ABSTRACT

The vehicle-use generator includes a rotor having a field winding wound therearound and configured to be belt-driven by a vehicle engine, a stator disposed radially outwardly of the rotor and having a stator winding wound therearound, a frame supporting therein the rotor and the stator, and a pulley fitted to one end of a rotating shaft of the rotor. The pulley is made of glass-reinforced resin having a heat-treated plating film formed on at least a belt-contact surface thereof.

### CROSS-REFERENCE TO RELATED APPLICATION

This application is related to Japanese Patent Application No. 2005-209344 filed on Jul. 20, 2005, the contents of which are hereby incorporated by reference.

### BACKGROUND OF THE INVENTION

1. Field of the Invention

The present invention relates to a vehicle-use generator (alternator) mounted on a vehicle such as a passenger car or a truck.

2. Description of Related Art

It is common that the vehicle-use generator is provided with a metal pulley which is belt-driven by a vehicle engine. However, in view of reduction of manufacturing cost and weight of the vehicle-use generator, a resin pulley is beginning to be used instead of the metal pulley.

It is a matter of course that the pulley of the vehicle-use generator is required to have a high mechanical strength and a high wear resistance. In addition, since the vehicle-use generator gives off heat, the pulley is also required to have a high heat resistance so that the mechanical strength thereof does not lower when the temperature rises. To satisfy these requirements, it is known to glass-reinforcing the resin pulley, and to form a plating film on the surface of the glass-reinforced resin pulley in order to reduce aggression of the glass fibers, as disclosed, for example, in Japanese Patent Publication No. 2002-5268 (pages 3-8, FIGS. 1-6).

However, the resin pulley disclosed in this patent document is intended for use in a compressor mounted on a vehicle, whose rotational speed is 9,000 rpm at a maximum. On the other hand, the maximum rotational speed of a common vehicle-use generator is as high as 20,000 rpm, because the ratio of the diameter of a crank pulley of a vehicle engine to the diameter of a pulley of a vehicle-use generator (may be referred to as “pulley ratio” hereinafter) is set at a large value so that the generator can generate sufficient electric power even when the engine is running at a low speed. The wear resistance of such a glass-reinforced resin pulley is not enough to be used as a pulley of a vehicle-use generator (may be referred to as a generator pulley hereinafter) whose maximum rotational speed is as high as 20,000 rpm. Accordingly, if such a glass-reinforced resin pulley is used as the generator pulley, the plating film formed on the surface thereof is worn out to cause the glass fibers to be exposed, as a result of which the belt is damaged and the life of the belt is therefore shortened.

If the diameter of the generator pulley is reduced by half or more to increase the pulley ratio, since the winding diameter of the belt becomes small and the distortion of the inner surface of the belt becomes large at a portion in contact with the generator pulley, the above described problem becomes even worse.

### SUMMARY OF THE INVENTION

The present invention provides a vehicle-use generator including:

a rotor having a field winding wound therearound and configured to be belt-driven by a vehicle engine;

a stator disposed radially outwardly of the rotor and having a stator winding wound therearound;

a frame supporting therein the rotor and the stator; and

a pulley fitted to one end of a rotating shaft of the rotor;

wherein the pulley is made of glass-reinforced resin having a heat-treated plating film formed on at least a belt-contact surface thereof.

The plating film may be a nickel non-electrolytic plating film.

The pulley may be integrally provided with a metal insert member having a through hole through which the rotating shaft is inserted. The both axial end surfaces of the metal insert member may serve as fitting surfaces of the pulley.

The Vickers hardness of the plating film may be higher than 1,000.

According to the present invention, it becomes possible to use a resin pulley for a vehicle-use generator whose maximum rotational speed is as high as 20,000 without reducing the life of a belt transmitting a torque from a vehicle engine to this vehicle-use generator, because the heat-treated plating film has a sufficiently high resistance to the exposure of the glass fibers contained therein.

Other advantages and features will become apparent from the following description including the drawings and claims.

### BRIEF DESCRIPTION OF THE DRAWINGS

In the accompanying drawings:

FIG. 1 is a diagram showing a structure of a vehicle-use generator according to an embodiment of the invention;

FIG. 2 is a partial cross-sectional view of a pulley of the vehicle-use generator according to the embodiment of the invention; and

FIG. 3 is a half cross-sectional view of a pulley of a variant of the vehicle-use generator according to the embodiment of the invention.

### PREFERRED EMBODIMENTS OF THE INVENTION

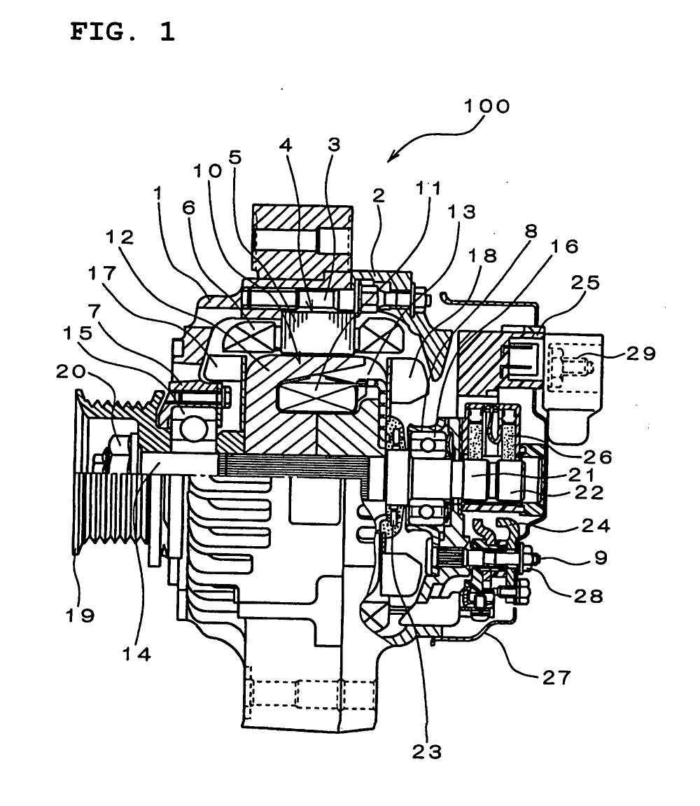

FIG. 1 shows a structure of a vehicle-use generator 100 according to an embodiment of the invention. As shown in this figure, the generator 100 includes a front frame 1, a rear frame 2, a stator 4, a rotor 10, a rectifier device 24, a voltage control device 25, a brush device 26, and a cover 27.

The front frame 1 and the rear frame 2, each of which has a bowl-like shape, are fastened to each other by a plurality of bolts 3 in such a state that their opening portions abut against each other. The stator 4 is fixed to the inner periphery of the front frame 1. The front frame 1 is integrally provided with a cylindrical bearing box 7. The rear frame 2 has an iron bearing box 8 mounted thereon by a knurled bolt 9.

The stator 4, which includes a stator core 5 and a stator winding 6, is disposed radially outwardly of the rotor 10. The rotor 10, which includes a field winding 11, pole cores 12 and 13, a rotating shaft 14, is rotatably supported by bearings 15 and 16 respectively housed in the bearing boxes 7 and 8. The pole cores 12 and 13 are respectively provided with centrifugal cooling fans 17, 18 at their axial end faces. The cooling fan 17 on the front side is of the diagonal flow type in which the blades thereof are inclined forward with respect to the rotational direction of the rotor 10 in order to supply cooling air to the field winding 11. A pulley 19 is secured to the front end of the rotating shaft 14 by a nut 20, so that the generator 100 is belt-driven by a vehicle engine (not shown). The rotating shaft 14 has a pair of slip rings 21, 22 at its rear end situated outside the rear frame 2. These slip rings 21, 22 are electrically connected to the field winding 11 through a conductor 23.

Electric components including the rectifier device 24, voltage control device 25, and brush device 26 are mounted to the axial end face of the rear frame 2. The rectifier device 24 converts a three-phase AC voltage outputted from the three-phase stator winding 6 into a DC voltage as an output voltage of the generator 100. The voltage control device 25 controls the output voltage by adjusting a field current flowing into the field winding 11. The brush device 26, which is for passing the field current from the rectifier device 24 to the field winding 11 of the rotor 10, includes two brush members which are in slide contact with the slip rings 21 and 22, respectively.

The cover 27, which is made of metal, is for protecting the electric components such as the rectifier device 24, voltage control device 25 and brush device 26 which are disposed outside the rear frame 2. This cover 27 is secured to the bolt 9 protruding from the rear frame 2 by a nut 28 with the rectifier device 24 being held therebetween. The cover 27 is formed with cooling air inlet windows circularly located in the vicinity of the brush device 26.

The rotor 10 of the generator 100 having the above described structure rotates when a torque is transmitted from the vehicle engine to the pulley 19 through a rubber belt or the like. In this state, when the field current is supplied to the field winding 11 of the rotor 10, claw portions of the pole cores 12, 13 are excited, as a result of which the three-phase AC voltage is induced in the stator winding 6, and accordingly the DC voltage is outputted from an output terminal 29 of the rectifier device 24 as the output voltage of the generator 100.

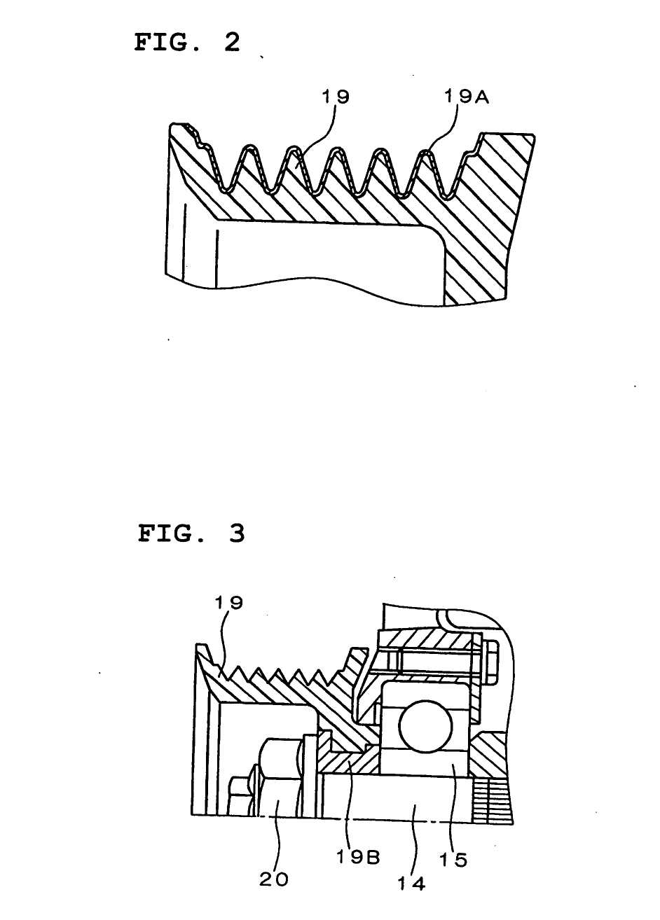

FIG. 2 is a partial cross-sectional view of the pulley 19. The pulley 19, which is made of a glass-reinforced resin, has a plurality of grooves at its surface in contact with the belt. As a resin material of the pulley 19, a thermosetting resin such as phenol resin and copna resin, or a thermoplastic resin such as nylon and polyphenylene sulfide may be used. The resin material is mixed and knead with glass fibers as reinforcement. The pulley 19 is formed with a plating film 19A at least at its belt-contact surface. The plating film 19A may be formed by electrolytic plating or non-electrolytic plating. A nickel non-electrolytic plating film has a high wear resistance and a high heat resistance although it can be formed at a relatively low cost. Besides, the wear resistance and heat resistance of the nickel non-electrolytic plating film can be further improved through the addition of a compounding agent such as phosphorus and boron.

In this embodiment, the plating film 19A formed on the surface of the pulley 19 is subjected to a heat treatment where the plating film 19A is kept at a constant temperature for a predetermined time period in order to increase the hardness of the plating film 19A. In a case where a nickel non-electrolytic plating film is formed as the plating film 19A, the Vickers hardness of the plating film 19A can be increased from about 500 to 1000 or higher by keeping the plating film 19A at 400 degrees C. for 60 minutes.

As explained above, in this embodiment, the glass-reinforced resin pulley 19 is formed with the plating film 19A, and this plating film 19A is subjected to the heat treatment in order to increase the hardness thereof to thereby improve the wear resistance thereof. The plating film 19A subjected to the heat treatment has a sufficiently high resistance to the exposure of the glass fibers contained therein. Accordingly, with this embodiment, it becomes possible to use a resin pulley for a vehicle-use generator whose maximum rotational speed is as high as 20,000 without reducing the life of a belt transmitting a torque from a vehicle engine to this vehicle-use generator.

It is a matter of course that various modifications can be made to the above described embodiment.

For example, as shown in FIG. 3, the pulley 19 may have a metal insert member 19B having a through hole through which the rotating shaft 14 is inserted, and having a front end surface against which the nut 20 abuts and a rear end surface against which the bearing 15 abuts. The metal insert member 19B may be formed by insert molding.

The metal insert member 19B reinforces the pulley 19 at the portions to which axial stresses are applied by the nut 20 and the bearing 15, to thereby prevent the nut 20 from loosening due to deformation of these portions.

The above explained preferred embodiments are exemplary of the invention of the present application which is described solely by the claims appended below. It should be understood that modifications of the preferred embodiments may be made as would occur to one of skill in the art.

What is claimed is:

1. A vehicle-use generator comprising:
a rotor having a field winding wound therearound and configured to be belt-driven by a vehicle engine;
a stator disposed radially outwardly of said rotor and having a stator winding wound therearound;
a frame supporting therein said rotor and said stator; and
a pulley fitted to one end of a rotating shaft of said rotor;
wherein said pulley is made of glass-reinforced resin having a heat-treated plating film formed on at least a belt-contact surface thereof.

2. The vehicle-use generator according to claim 1, wherein said plating film is a nickel non-electrolytic plating film.

3. The vehicle-use generator according to claim 1, wherein said pulley is integrally provided with a metal insert member having a through hole through which said rotating shaft is inserted.

4. The vehicle-use generator according to claim 3, wherein both axial end surfaces of said metal insert member serve as fitting surfaces of said pulley.

5. The vehicle-use generator according to claim 2, wherein Vickers hardness of said plating film is higher than 1,000.
